(19) United States
(12) Patent Application Publication
(10) Pub. No.: US 2017/0230186 A1
(43) Pub. Date: Aug. 10, 2017

(54) FILE MANAGEMENT APPARATUS AND METHOD FOR VERIFYING INTEGRITY

(71) Applicant: SAMSUNG ELECTRONICS CO., LTD., Suwon-si (KR)

(72) Inventor: Kwang-ho LEE, Seoul (KR)

(21) Appl. No.: 15/424,964

(22) Filed: Feb. 6, 2017

(30) Foreign Application Priority Data
Feb. 5, 2016 (KR) 10-2016-0015057
Feb. 25, 2016 (KR) 10-2016-0022701

(51) Int. Cl. H04L 9/32; G06F 3/06

(52) U.S. Cl. CPC H04L 9/3263; G06F 3/0611; G06F 3/064; G06F 3/0673

(57) ABSTRACT

A file management apparatus and a method for verifying integrity are provided. The method includes storing a plurality of pieces of data comprising a file as units of chunks and storing the chunks in a memory, determining whether the file has integrity by comparing determined certification values of the chunks of the file with pre-stored certification values of the chunks based on an execution command, and executing the file based on the integrity determination result. The file management apparatus improves a performance of a whole system by partially performing integrity verifications of a plurality of pieces of data comprising a file to be executed.

### CROSS-REFERENCE TO RELATED APPLICATIONS

This application is based on and claims priority under 35 U.S.C. §119 to Korean Patent Application Nos. 10-2016-0015057 and 10-2016-0022701, filed on Feb. 5 and Feb. 25, 2016, in the Korean Intellectual Property Office, respectively, the disclosures of which are incorporated by reference herein in their entireties.

### BACKGROUND

Field

The present disclosure relates generally to a file management apparatus and a method for verifying integrity, and for example, to a file management apparatus and a method for partially verifying integrity of a file according to a characteristic of the file.

Description of Related Art

A general file integrity verifying method determines whether a corresponding file has integrity on a block storage layer that performs a connection operation between a file management apparatus (a file system) managing the file and a memory storing the file between the file management apparatus and the memory.

Whether the file has integrity is determined through the block storage layer, the determination of whether the file has integrity is irrelevant to the characteristic of the file managed by the file management apparatus, and thus whether all files have integrities are determined.

As described above, an existing integrity verifying method causes a deterioration in a performance of a whole system by determining whether all files have integrities.

Therefore, a high-performance memory may be used to improve a system performance deterioration problem. However, using the high-performance memory generates additional cost, and thus manufacturing unit cost increases.

### SUMMARY

Example embodiments of the present disclosure address the above disadvantages and other disadvantages not described above.

The present disclosure improves a performance of a whole system by determining whether a file to be executed has integrity based on a characteristic of the file and partially determining whether a plurality of pieces of data comprising the file have integrities only if necessary.

According to an example aspect of the present disclosure, a method of verifying integrity using a file management apparatus, includes receiving a file comprising a plurality of pieces of data, arranging the plurality of pieces of data of the file as units of chunks and storing the chunks in a memory, determining whether the file has integrity by comparing a certification value of at least one of the chunks of the file with a pre-stored certification value corresponding to the at least one of the chunks based on an execution command, and executing the file based on the integrity determination result.

The memory may store a super block area configured to store all information about a volume, a volume meta area configured to store at least one selected from information for managing the file and execution information of the file, and a volume block configured to include a file object area storing the file composed as the units of chunks and information about the file.

The file object area may include a file meta area configured to store certification values respectively corresponding to the chunks of the plurality of pieces of data comprising the file. The determining the integrity may include detecting positions of the chunks of the file and the file meta area from the file object area based on information stored in the volume meta area, determining certification values of the chunks of the file based on the detected positions of the chunks, and determining whether the file has integrity by acquiring certification values of the chunks of the file with reference to the detected file meta area and comparing the acquired certification values of the chunks with the determined certification values of the chunks.

The file meta area may further store an encryption value that is determined based on certification values of pieces of information included in the file meta area and a predefined encryption algorithm. The determining the integrity further may include determining certification values of the pieces of information included in the file meta area based on information stored in the volume meta area and determining an encryption value using the determined certification values and the encryption algorithm, and determining whether the file object area has integrity by comparing the determined encryption value with an encryption value stored in the file meta area.

The volume may further include a global file meta area configured to store information about a particular file. The global file meta area may store an encryption value that is determined based on certification values of pieces of information comprising the particular file and a predefined encryption algorithm.

The particular file may be a file that is initially executed when booting a system.

The determining the integrity may include, when booting the system, determining certification values of pieces of information included in the global file meta area based on information stored in the volume meta area and determining an encryption value using the determined certification values and the encryption algorithm, comparing the determined encryption value with an encryption value stored in the global file meta area, in response to the determined encryption value and the stored encryption value corresponding to each other, determining certification values of chunks of a file included in the global file meta area, and determining whether the file included in the global file meta area has integrity by comparing the determined certification values of the chunks with certification values of the chunks stored in the global file meta area.

The determining the integrity may include: in response to the file being determined as an executable file based on execution information included in the volume meta area, determining whether the file has integrity.

The volume meta area may store a certification value for verifying integrity of the super block area. The determining the integrity may further include determining whether the super block area has integrity by determining certification values of pieces of information included in the super block area and comparing the determined certification values with certification values stored in the volume meta area.

According to another example aspect of the present disclosure, a file management apparatus includes a memory configured to arrange a plurality of pieces of data of a file as units of chunks and to store the chunks, and a processor configured to determine whether the file has integrity by comparing determined certification value of at least one of the chunks of the file with a pre-stored certification value corresponding to the at least one the chunks and to execute the file based on the integrity determination result based on an execution command.

The memory may store a super block area configured to store all information about a volume, a volume meta area configured to store at least one selected from information for managing the file and execution information of the file, and a volume block configured to include a file object area storing the file composed as the units of chunks and information about the file.

The file object area may include a file meta area configured to store certification values respectively corresponding to chunks of a plurality of pieces of data composing the file. The processor may include a file controller configured to detect positions of the chunks of the file and the file meta area from the file object area based on information stored in the volume meta area, and a certification processor configured to determine certification values of the chunks of the file based on the detected positions of the chunks. The certification processor may determine whether the file has integrity by acquiring certification values of the chunks of the file with reference to the detected file meta area and comparing the acquired certification values of the chunks with the determined certification values of the chunks.

The file meta area may further store an encryption value that is determined based on certification values of pieces of information included in the file meta area and a predefined encryption algorithm. The processor may further include an encryption processor configured to determine certification values of the pieces of information included in the file meta area based on information stored in the volume meta area and calculate an encryption value using the determined certification values and the encryption algorithm. The encryption processor may determine whether the file object area has integrity by determining whether the determined encryption value corresponds to an encryption value stored in the file meta area.

The volume may further include a global file meta area configured to store information about a particular file. The global file meta area may store an encryption value that is determined based certification values of pieces of information composing the particular file and a predefined encryption algorithm.

The particular file may be a file that is initially executed when booting a system.

When booting the system, the encryption processor may determine whether the global file meta area has integrity by determining certification values of pieces of information included in the global file meta area based on information stored in the volume meta area, determining an encryption value using the determined certification values and the encryption algorithm, and comparing the determined encryption value with an encryption value stored in the global file meta area. In response to the determined encryption value and the stored encryption value corresponding to each other, the certification processor may determine whether a file included in the global file meta area has integrity by determining certification values of chunks of the file included in the global file meta area and comparing the determined certification values of the chunks with certification values of the chunks stored in the global file meta area

In response to the file being determined as an executable file based on execution information included in the volume meta area, the file controller may determine whether the file has integrity.

The volume meta area may store a certification value for verifying integrity of the super block area. The certification processor may determine whether the super block area has integrity by determining certification values of pieces of information included in the super block area and comparing the determined certification values with certification values stored in the volume meta area.

The method further includes selecting at least one chunk to be used from among a plurality of chunks stored in the memory, calculating a certification value for the selected at least one chunk and comparing the calculated certification value with a predetermined certification value for the selected at least one chunk.

The processor selects at least one chunk to be used from among a plurality of chunks stored in the memory, calculates a certification value for the selected at least one chunk, and compare the calculated certification value with a predetermined certification value for the selected at least one chuck.

According to various example embodiments of the present disclosure as described above, a file management apparatus may improve a performance of a whole system by partially determining whether a plurality of pieces of data comprising a file to be executed have integrities based on a characteristic of the corresponding file and a need for the determination.

Additional and/or other aspects and advantages of the disclosure will be set forth in part in the description which follows and, in part, will be apparent from the description.

### BRIEF DESCRIPTION OF THE DRAWINGS

The above and/or other aspects, features and attendant advantages of the present disclosure will be more apparent and readily understood from the following detailed description, taken in conjunction with the accompanying drawings, in which like reference numerals refer to like elements, and wherein:

FIG. 1 is a block diagram illustrating an example file management apparatus according to an example embodiment of the present disclosure;

FIG. 2 is a block diagram illustrating ane processor according to an example embodiment of the present disclosure;

FIG. 3 is a diagram illustrating an example structure of a volume area storing file-related information according to an example embodiment of the present disclosure;

FIG. 4 is a diagram illustrating an example structure of a file meta area of a file object area according to an example embodiment of the present disclosure;

FIG. 5 is a diagram illustrating an example structure of a global file meta area according to an example embodiment of the present disclosure;

FIG. 6 is a flowchart illustrating an example integrity verifying method of a file management apparatus according to an example embodiment of the present disclosure;

FIG. 7 is a flowchart illustrating an example method of determining whether a file stored in a volume area has integrity in a file management apparatus, according to an example embodiment of the present disclosure;

FIG. 8 is a flowchart illustrating an example method of determining whether a super block area of a volume has integrity in a file management apparatus, according to an example embodiment of the present disclosure; and

FIG. 9 is a flowchart illustrating an example method of verifying integrity of a file when booting a system in a file management apparatus, according to an example embodiment of the present disclosure.

### DETAILED DESCRIPTION

Various example embodiments of the present disclosure will now be described in greater detail with reference to the accompanying drawings.

In the following description, same drawing reference numerals are used for the same elements even in different drawings. The matters defined in the description, such as detailed construction and elements, are provided to assist in a comprehensive understanding of the disclosure. Thus, it is apparent that the example embodiments of the present disclosure can be carried out without those specifically defined matters. Also, well-known functions or constructions are not described in detail since they would obscure the disclosure with unnecessary detail.

Prior to a detailed description of the present disclosure, describing methods of the present disclosure and drawings will be described. The terms used herein are selected as general terms that are currently widely used in consideration of their functions in the present disclosure. However, these terms may depend on intentions or legal or technical interpretations of those skilled in the art, emergences of new technologies, and the like. Also, there may be some terms that are arbitrarily selected. These terms may be construed to have meanings defined in the present disclosure and may be understood based on whole contents of the present disclosure and common technical knowledge of the art as long as there are no detailed definitions of the terms.

Also, the same reference numerals or symbols described in the attached drawings denote parts or elements that actually perform the same functions. For convenience of descriptions and understanding, the same reference numerals or symbols are used and described in different example embodiments. In other words, although elements having the same reference numerals are all illustrated in a plurality of drawings, the plurality of drawings do not mean one example embodiment.

Also, the terms “first”, “second”, etc. may be used to describe diverse components, but the components are not limited by the terms. The terms are only used to distinguish one component from the others. For example, used orders, arrangement orders, or the like of elements that are combined with these ordinal numbers may not be limited by the numbers. If necessary, the ordinal numbers may be respectively replaced and used.

The singular expression also includes the plural meaning as long as it does conflict with the context. In the present disclosure, the terms “include” and “comprise” designate the presence of features, numbers, steps, operations, components, elements, or a combination thereof that are written in the disclosure, but do not exclude the presence or possibility of addition of one or more other features, numbers, steps, operations, components, elements, or a combination thereof.

In the example embodiment of the present disclosure, the term “module”, “unit”, or “part” may, for example, be referred to as an element that performs at least one function or operation, and may be implemented with hardware, software, or a combination of hardware and software. In addition, a plurality of “modules”, a plurality of “units”, a plurality of “parts” may be integrated into at least one module or chip except for a “module”, a “unit”, or a “part” which has to be implemented with specific hardware, and may be implemented with at least one processor (not shown).

Also, when any part is connected to another part, this includes a direct connection and an indirect connection through another medium. Unless otherwise defined, when any part includes any element, it may refer to a situation in which any part further include other elements without excluding other elements.

Hereinafter, various example embodiments of the present disclosure will be described in greater detail with reference to the attached drawings.

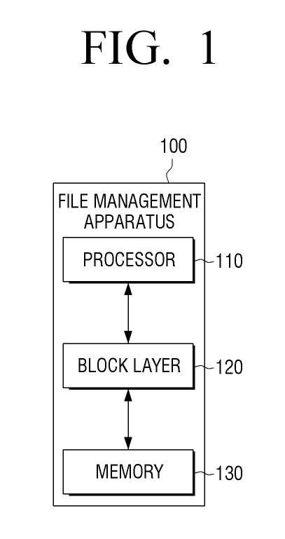

FIG. 1 is a block diagram illustrating an example file management apparatus 100 according to an example embodiment of the present disclosure

As illustrated in FIG. 1, the file management apparatus 100 may include a processor (e.g., including processing circuitry) 110, a block layer 120, and a memory 130.

The processor 110 may include various circuitry that controls operations of elements composing the file management apparatus 100. In particular, the processor 110 performs an integrity verification of an executable file corresponding to a user command among a plurality of files stored in the memory 130 or an integrity verification of an executable file that is executed when booting a system.

The block layer 120 operates as a medium for transmitting and receiving file-related information between the processor 110 and the memory 130. Therefore, the processor 110 and the memory 130 may transmit and receive information about a file through the block layer 120.

The memory 130 stores a plurality of files. In other words, the memory 130 may include a plurality of pieces of data comprising each of a plurality of files as units of chunks and then store the chunks in a volume area. In other words, a plurality of pieces of data comprising a file may be dispersedly stored as units of chunks in a volume area.

As described above, the memory 130 that stores a plurality of files may be realized as a recording medium that may store file-related information in the memory 130 when the memory 130 is cut off from power supply, e.g., as a recording medium such as a read only memory (ROM), a hard disc, or a flash disc.

For example, the processor 110 performs an integrity verification of a volume area storing a file for executing an application requested by a user based on an execution command of the corresponding application.

To be specific, the processor 110, according to a command to execute an application requested by a user, checks positions of at least one chunk from a volume area storing the file for executing the application and calculates certification values of the at least one checked chunk.

Thereafter, the processor 110 compares the certification values of the at least one chunk with respect to the file and the prestored certification values and determines whether the certification values correspond to the pre-stored certification values. That is, the processor 110 selects at least one chunk to use out of the plurality of chunks prestored in the memory 130 and calculates certification values with respect to the selected chunks. The processor 110 compares the certification values calculated from the selected chunk and the certification values prestored in response to the chunk and determines whether the calculated certification values correspond to the prestored certification values. As a result of the determination, if the two certification values match with each other, the processor 110 determines that the corresponding file has integrity.

If at least one of the determined certification values of the chunks is different from a pre-stored certification value, the processor 110 determines that an error occurs in a chunk having two different certification values. In other words, if at least one of the determined certification values of the chunks is different from a pre-stored certification value, the processor 110 determines that a chunk having two different certification values does not have integrity.

Here, the processor 110 may determine whether each chunk corresponding to a point of time when each chuck is used among all chunks comprising a file has integrity through an integrity-related processing operation described above.

For example, a file may be configured as first through third chunks. Also, if a chunk corresponding to a point of time when a chunk is to be currently used is a first chunk, the processor 110 may determine whether the first chunk corresponding to the point of time when the chunks is to be currently used has integrity.

However, the present disclosure is not limited thereto, and if there are a plurality of chunks corresponding to a point of time when a chunk is to be currently used, the processor 110 may determine whether at least two or more chucks corresponding to the point of time when the chunk is to be currently used among the first through third chunks have integrities.

As described above, the file management apparatus 100 according to the present disclosure may improve a performance of a whole system by dispersedly storing a plurality of pieces of data comprising a file as units of chunks in the memory 130 and performing integrity verifications of the dispersedly stored chunks, in comparison with an existing file management apparatus determining whether all files have integrities.

Hereinafter, an operation of the processor 110 of the file management apparatus 100 performing an integrity verification of a file stored in a volume area of the memory 130 will be described in greater detail.

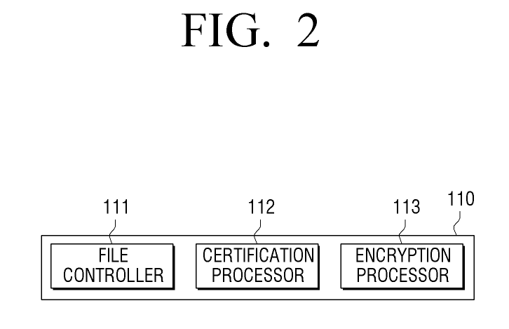

FIG. 2 is a block diagram illustrating an example of the processor 110, according to an example embodiment of the present disclosure.

As illustrated in FIG. 2, the processor 110 includes a file controller 111, a certification processor 112, and an encryption processor 113.

The file controller 111 detects a plurality of chunks of a requested file and an area storing certification values of the chunks from a volume area storing the requested file based on a file request for an application corresponding to an execution command of a user. For example, a file of the application corresponding to the execution command of the user may include a plurality of pieces of data, and the plurality of pieces of data may be dispersedly stored as units of chunks in the volume area. Therefore, the file controller 111 detects an area storing a plurality of chunks of a requested file and determined certification values of the chunks from the volume area storing the requested file.

If the area storing the plurality of chunks of the requested file and the determined certification values of the chunks is detected, the certification processor 112 may verify integrity of the requested file by determining certification values of the chunks with reference to the detected area and comparing the determined certification values of the chunks and pre-stored certification values of the chunks.

Before performing an integrity verification of the requested file through the comparison between the determined certification values of the chunks of the file and the pre-stored certification values of the chunks, the encryption processor 113 performs an integrity verification of the area storing the plurality of chunks of the requested file.

If integrity of the area storing the plurality of chunks of the requested file and integrity of a chunk stored in the corresponding area are verified, the file controller 111 may execute the requested file.

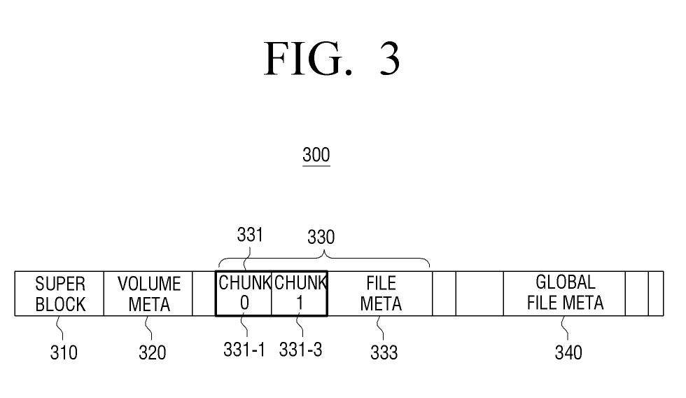

FIG. 3 is a diagram illustrating an example structure of a volume area storing file-related information, according to an example embodiment of the present disclosure.

As illustrated in FIG. 3, a volume area 300 that dispersedly stores a plurality of pieces of data comprising a file as units of chunks may include a super block area 310, a volume meta area 320, a file object area 330, and a global file meta area 340.

The super block area 310 may refer, for example, to an area that stores all information about the volume area 300. According to example embodiments, the super block area 310 may be an area that stores volume size information, position information of each area, information about a file system, such as a New Technology File System (NTFS), a File Allocation Table (FAT), or an Extended File System 4 (EXT4), and the like

The volume meta area 320 may refer, for example, to an area that stores at least one selected from information for managing a file, execution information about the file, and a certification value for verifying integrity of a super block area.

The file object area 330 may refer, for example, to an area that stores a file as units of chunks and information about the file. Here, the information about the file may include compression information into which a plurality of pieces of data are compressed as units of chunks, size information, certification information, position information of each of the chunks, and the like.

The file object area 330 as described above includes a chunk area 331 that dispersedly stores a plurality of chunks of a plurality of pieces of data comprising a file and a file meta area 333 that stores information about the plurality of chunks.

The chunk area 331 includes a first chunk chunk0 331-1 and a second chunk chunk1 331-3 into which the plurality of pieces of data composing the file are compressed.

Also, the file meta area 333 stores position information, compression information, and certification information of each of chunks (the first and second chunks 331-1 and 331-3) stored in the chunk area 331, and the like. Here, the certification information may include calculated hash values of the chunks (the first and second chunks 331-1 and 331-3) stored in the chunk area 331, and the hash values of the chunks may be stored in a table form. In addition, the certification information may include an encryption value that is calculated by using the hash values of the chunks (the first and second chunks 331-1 and 331-3) stored in the chunk area 331 and a predefined encryption algorithm.

Also, the global file meta area 340 may refer, for example, to an area that stores information about a particular file. Here, according to example embodiments, the particular file may be a file that is initially executed when booting a system.

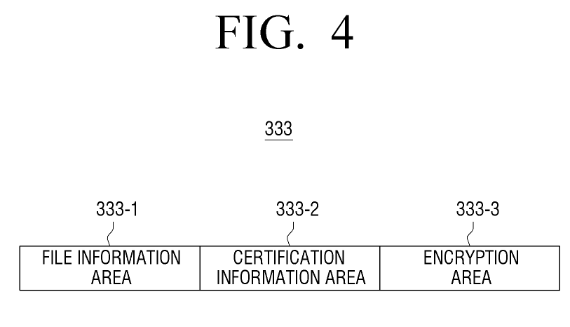

FIG. 4 is a diagram illustrating an example structure of a file meta area of a file object area, according to an example embodiment of the present disclosure.

As illustrated in FIG. 4, the file meta area 333 includes a file information area 333-1, a certification information area 333-2, and an encryption area 333-3.

As described above with reference to FIG. 3, the file information area 333-1 stores position information and compression information of each of the chunks (the first and second chunks 331-1 and 331-3) stored in the chunk area 331, and the like.

The certification information area 333-2 may refer, for example, to an area for verifying integrity of each of the first and second chunks 331-1 and 331-3 stored in the chunk area 331. For this, the certification information area 333-2 stores determined certification values of the chunks (the first and second chunks 331-1 and 331-3) stored in the chunk area 331 in a table form. Here, the certification values may be hash values that are determined using a hash function generating a pseudorandom number having a fixed information length.

Therefore, the certification information area 333-2 may determine hash values of the chunks (the first and second chunks 331-1 and 331-3) stored in the chunk area 331 by using a hash function and store the determined hash values of the chunks in a table form.

The encryption area 333-3 may refer, for example, to an area for verifying integrity of the file object area 330. For this, the encryption area 333-3 stores an encryption value using hash values determined from all information stored in the file meta area 333 and a predefined encryption algorithm. For example, and without limitation, the encryption algorithm may be a Rivest Shamir Adleman (RSA) algorithm that makes a public key and a private key into a set, and encrypts and decrypts the set.

However, the present disclosure is not limited thereto, and an encryption value of the file meta area 333 may be determined by using various types of well-known encryption algorithms and then stored in the encryption area 333-3.

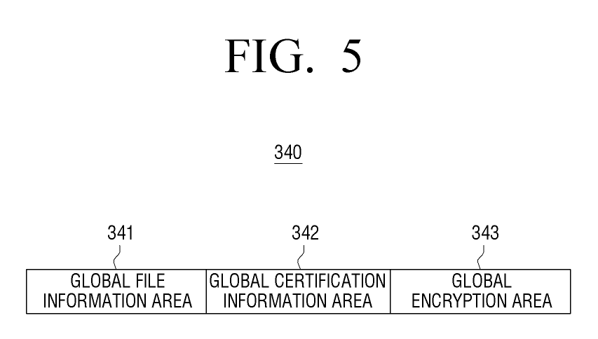

FIG. 5 is a diagram illustrating an example structure of a global file meta area according to an example embodiment of the present disclosure.

As illustrated in FIG. 5, the global file meta area 340 may refer, for example, to an area that stores information about a particular file. Here, the particular file may be a file that needs to be initially accessed when booting a system. In other words, the particular file may be a file that needs to be initially accessed when booting the system, among files stored in the volume area 300 of the memory 130.

A plurality of files that need to be initially accessed may be stored in the global file meta area 340. In this case, the global file meta area 340 may include, for example, a global file information area 341, a global certification information area 342, and a global encryption area 343.

The global file information area 341 stores a plurality of chunks into which a plurality of pieces of data comprising at least one file defined as a particular file are compressed, position information and compression information of the chunks, and the like.

The global certification information area 342 may refer, for example, to an area for verifying integrity of each of the plurality of chunks of the at least one file defined as the particular file. For this, the global certification information area 342 stores determined certification values of the plurality of chunks of the at least one file stored in the global file information area 341. Here, the certification values may be hash values that are determined using a hash function generating a pseudorandom number having a fixed information length.

Therefore, the global certification information area 342 may determine hash values of a plurality of chunks of at least one file stored in the global file information area 341 and store the determined hash values of the chunks in a table form.

The global encryption area 343 may refer, for example, to an area for verifying integrity of the global file meta area 340. For this, the global encryption area 343 stores an encryption value using hash values determined from all information stored in the global file meta area 340 and a predefined encryption algorithm. Here, the encryption algorithm may be an RSA algorithm that makes a public key and a private key into a set, and encrypts and decrypts the set.

However, the present disclosure is not limited thereto, and an encryption value of the file object area 330 may be determined using various types of well-known encryption algorithms and then stored in the global encryption area 343.

As described above, when booting a system, the file management apparatus 100 according to the present disclosure may further rapidly perform an integrity verification of at least one file that needs to be initially accessed among files stored in the volume area 300 of the memory 130 by sorting out the at least one file from other files and storing the at least one file in the global file meta area 340.

Hereinafter, an operation of the processor 110 of the file management apparatus 100 of the present disclosure verifying whether a file stored in the volume area 300 has integrity will be described in greater detail.

As described above, the processor 110 includes the file controller 111, the certification processor 112, and the encryption processor 113.

For example, the file controller 111 detects a position of a chunk of a file requested to be executed and the file meta area 333 from the file object area 330 based on information stored in the volume meta area 320. In other words, the file controller 111 detects position information of each of a plurality of chunks of a file requested to be executed and position information of the file meta area 333 from the chunk area 331 based on information stored in the volume meta area 320.

According to another example aspect of the present disclosure, the file controller 111 may determine whether to perform an integrity verification of a file requested to be executed, based on execution information of the corresponding file among a plurality of pieces of information stored in the volume meta area 320 and then perform the above-described operation based on the determination result.

For example, the file controller 111 determines whether a file requested to be executed is an image file such as jpg or an executable file for executing a program such as exe, based on execution information of the corresponding file among a plurality of pieces of information stored in the volume meta area 320. Alternatively, even if a corresponding file object area is mapped on an attribute such as VM_EXEC or the like, the file controller 111 may determine whether a file is an image file or an executable file based on information stored in the volume meta area 320.

If the file requested to be executed is the executable file according to the determination result, the file controller 111 may determine that an integrity verification of the corresponding file is to be performed, detect position information of each of the plurality of chunks of the file requested to be executed and position information of the file meta area 333, and perform an integrity verification of merely a necessary chunk.

If the file requested to be executed is the image file, the file controller 111 may determine that the integrity verification of the corresponding file is not to be performed and may merely detect position information of each of the plurality of chunks of the file requested to be executed.

If it is determined that the integrity verification of the file requested to be executed is to be performed, the certification processor 112 determines certification values respectively corresponding to a plurality of chunks of a corresponding file detected from the file controller 111 based on position information of each of the plurality of chunks. Here, the certification values may be hash values that are determined using a hash function.

Thereafter, the certification processor 112 acquires certification values of the chunks of the file requested to be executed with reference to the certification information area 333-2 of the file meta area 333 detected by the file controller 111. The certification processor 112 determines whether the file requested to be executed has integrity by comparing the certification values respectively determined from the chunks of the file requested to be executed with certification values of the chunks of the corresponding file acquired from the certification information area 333-2.

For example, if a certification value determined from a first chunk of a plurality of chunks of a file requested to be executed is different from a certification value pre-stored in relation to the first chunk, the certification processor 112 may determine that the first chunk does not have integrity.

If determined certification values of a plurality of chunks of a file requested to be executed all correspond to pre-stored certification values, the certification processor 112 may determine that the chunks of the file requested to be executed have integrities.

Before determining whether the file requested to be executed has integrity, the processor 110 of the file management apparatus 100 according to the present disclosure may perform an integrity verification of the file meta area 333 that stores information about the file requested to be executed through the encryption processor 113.

In other words, the encryption processor 113 determines a certification value of each of pieces of information included in the file meta area 333 based on information stored in the volume meta area 320 according to an execution command of a file for executing an application corresponding to a user command. Here, the certification value may be a hash value that is determined using a hash function. If the certification value of each of the pieces of information included in the file meta area 333 is determined as described above, the encryption processor 113 determines an encryption value by using the determined certification value and a predefined encryption algorithm. Here, according to example embodiments, the encryption algorithm may be an RSA algorithm.

If the encryption value of the information included in the file meta area 333 is determined, the encryption processor 113 determines whether the file meta area 333 has integrity by comparing the calculated encryption value with an encryption value stored in the encryption area 333-3 of the file meta area 333.

In other words, if the encryption value determined from the information included in the file meta area 333 corresponds to the encryption value stored in the encryption area 333-3, the encryption processor 113 determines that the file meta area 333 has integrity. If the encryption value determined from the information included in the file meta area 333 is different from the encryption value stored in the encryption area 333-3, the encryption processor 113 determines that the file meta area 333 does not have integrity.

As described above, the file management apparatus 100 according to the present disclosure may check whether a certification value is modulated by performing an integrity verification of the file meta area 333.

If it is determined that information about the file meta area 333 has integrity through an integrity verification, the certification processor 112 may determine whether a file requested to be executed has integrity through the above-described performed operation.

If initial booting of a system starts, the encryption processor 113 determines whether at least one file, which needs to be initially accessed among files stored in the volume area 300 of the memory 130, has integrity by accessing the global file meta area 340 storing information about the at least one file based on information stored in the volume meta area 320.

For example, if the initial booting of the system starts, the encryption processor 113 accesses the global file meta area 340 based on the information stored in the volume meta area 320. Thereafter, the encryption processor 113 calculates a certification value of each of pieces of information included in the global file meta area 340 and determines an encryption value of the global file meta area 340 by using the calculated certification value of each of the information and a predefined encryption algorithm. Here, the certification value may be a hash value that is determined through a hash function, and the encryption algorithm may be an RSA algorithm that makes a public key and a private key into a set, and encrypts and decrypts the set.

The encryption processor 113 compares an encryption value pre-stored in the global encryption area 343 and a pre-determined encryption value by accessing the global encryption area 343 included in the global file meta area 340 and determines whether the global file meta area 340 has integrity based on the comparison result.

In other words, if the pre-stored encryption value and the pre-calculated encryption value correspond to each other, the encryption processor 113 determines that the global file meta area 340 has integrity. Also, if the pre-stored encryption value and the pre-calculated encryption value do not correspond to each other, the encryption processor 113 determines that the global file meta area 340 does not have integrity.

If it is determined that the global file meta area 340 has integrity, the certification processor 112 determines certification values of chunks of at least one file included in the global file information area 341 by accessing the global file information area 341 included in the global file meta area 340. Thereafter, the certification processor 112 compares the determined certification values with certification values stored in the global certification area 342 included in the global file meta area 340.

Here, the certification values stored in the global certification area 342 may be values that are respectively determined from chunks of at least one file stored in the global file information area 341, and a plurality of certification values may be stored in a table form in the global certification area 342.

Therefore, the certification processor 112 compares certification values respectively determined from chunks of at least one file included in the global file information area 341 with certification values of chunks of at least one file pre-stored in the global certification area 342. If the determined certification values of the chunks of the at least one file correspond to the pre-stored certification values according to the comparison result, the certification processor 112 may determine that the at least one file included in the global file information area 341 has integrity. If the determined certification values of the chunks of the at least one file do not correspond to the pre-stored certification values, the certification processor 112 may determine that the at least one file included in the global file information area 341 does not have integrity.

As described above, the volume meta area 320 included in the volume area 300 may store a certification value for verifying integrity of the super block area 310. In other words, the volume meta area 320 may store certification values of pieces of information included in the super block area 310 in a table form. Here, the certification values may be hash values that are calculated by using a hash function.

Therefore, before performing an integrity verification of the file object area 330 or the global file meta area 340 as described above, the certification processor 120 may determine whether the super block area 310 has integrity by determining certification values of pieces of information included in the super block area 310 and comparing the determined certification values with certification values stored in the volume meta area 320.

If it is determined that the super block area 310 has integrity, the certification processor 120 and the encryption processor 130 may perform an integrity verification of the file object area 330 or the global file meta area 340 through a series of processing processes described above.

The file management apparatus 100 according to the present disclosure has been described in detail. Hereinafter, an integrity verifying method of the file management apparatus 100 according to the present disclosure will be described in greater detail.

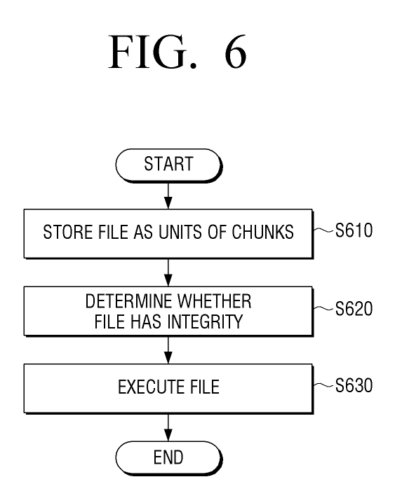

FIG. 6 is a flowchart illustrating an example integrity verifying method of a file management apparatus, according to an example embodiment of the present disclosure.

As illustrated in FIG. 6, the file management apparatus 100, when a file including a plurality of pieces of data is received, arranges the plurality of pieces of data of the file in units of chunks and stores in a memory (S610). In operation S620, the file management apparatus 100, based on an execution command, compares certification values of the at least one chunk and certification values prestored in response to at least one chunk and determines integrity. That is, the file management apparatus 100, when at least one chunk to be used is selected from among a plurality of chunks stored in a memory, calculates certification values of the selected chunk. Thereafter, the file management apparatus 100 compares the calculated certification values and the at least one selected chunk and determines integrity. In operation S630, the file management apparatus 100 executes the requested file based on the integrity determination result.

For example, the file management apparatus 100 checks positions of a plurality of chunks of a file for executing an application requested by a user from a volume area storing the file and determines certification values of the checked chunks based on an execution command of the application.

Thereafter, the file management apparatus 100 determines whether the determined certification values of the chunks of the corresponding file correspond to pre-stored certification values of the chunks by comparing the determined certification values of the chunks with the pre-stored certification values of the chunks. If the determined certification values of the chunks correspond to the pre-stored certification values according to the determination result, the file management apparatus 100 determines that the corresponding file is normal. In other words, if the determined certification values of the chunks of the file correspond to the pre-stored certification values, the file management apparatus 100 determines that the corresponding file has integrity.

If at least one of the determined certification values of the chunks is different from a pre-stored certification value, the file management apparatus 100 determines that an error occurs in a chunk having two different certification values. In other words, if the at least one of the determined certification values of the chunks is different from the pre-stored certification value, the file management apparatus 100 determines that the chunk having the two different certification values does not have integrity.

As described above, the file management apparatus 100 according to the present disclosure may improve a performance of a whole system by dispersedly storing a plurality of pieces of data comprising a file as units of chunks in the volume area 300 of the memory 130 and performing an integrity verification of each of the dispersedly stored chunks in comparison with an existing file management apparatus determining whether all files have integrity.

Hereinafter, a method of verifying integrity of a file stored in the volume area 300 in the file management apparatus 100 according to the present disclosure will be described in detail.

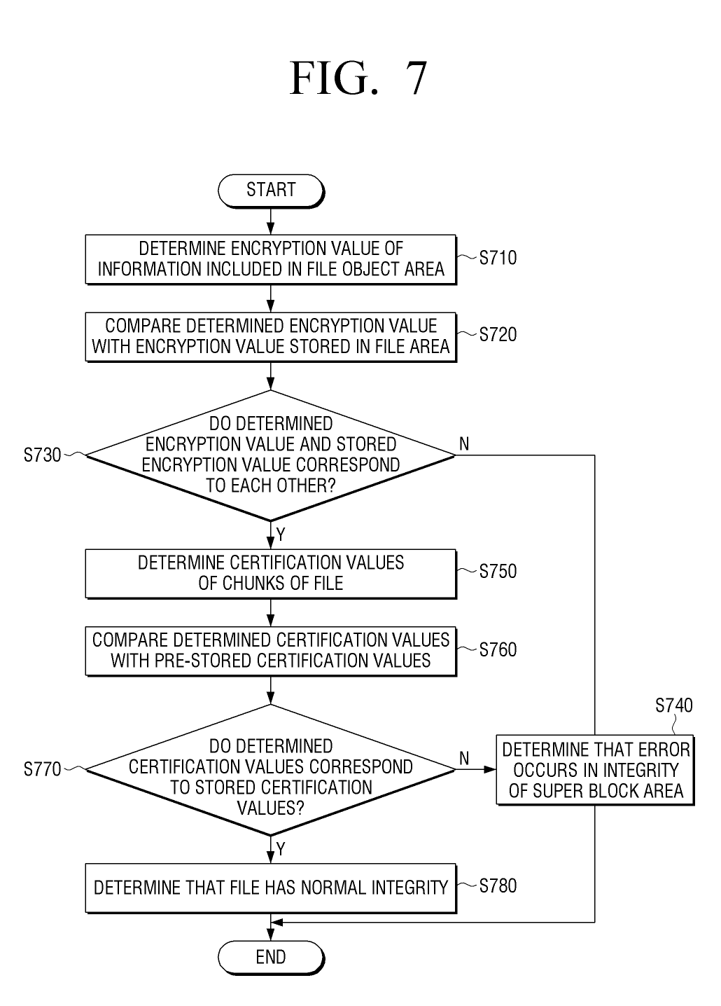

FIG. 7 is a flowchart illustrating an example method of determining whether a file stored in a volume area has integrity in a file management apparatus, according to an example embodiment of the present disclosure.

As illustrated in FIG. 7, the file management apparatus 100 performs an integrity verification of an area storing a file requested to be executed from the volume area 300 of the memory 130 storing the corresponding file based on an execution request for the file.

For example, as described above with reference to FIG. 3, the volume area 300 that dispersedly stores a plurality of pieces of data comprising a file as units of chunks may include the super block area 310, the volume meta area 320, and the file object area 330.

The super block area 310 may refer, for example, to an area that stores all information about the volume area 300. According to example embodiments, the super block area 310 may be an area that stores volume size information, position information of each area, information about a file system such as an NTFS, an FAT, or an EXT4, and the like.

The volume meta area 320 may refer, for example, to an area that stores at least one selected from information for managing a file, an execution information of the file, and a certification value for verifying integrity of a super block area.

The file object area 330 may refer, for example, to an area that stores a file comprised as units of chunks and information about the file. Here, the information about the file may include compression information into which a plurality of pieces of data comprising a file are compressed as units of chunks, size information, certification information, position information of the chunks, and the like.

The file object area 330 as described above may include the chunk area 331 that dispersedly stores a plurality of chunks of a plurality of pieces of data composing a file and the file meta area 333 that stores information about the plurality of chunks.

As described above with reference to FIG. 4, the file meta area 333 includes the file information area 333-1, the certification information area 333-2, and the encryption area 333-3.

The file information area 333-1 stores position information, compression information, and the like of chunks of a file stored in the chunk area 331.

The certification information area 333-2 may refer, for example to an area for verifying integrity of each of the chunks of the file stored in the chunk area 331. For this, the certification information area 333-2 stores determined certification values of the chunks stored in the chunk area 331 in a table form. Here, the certification values may be hash values that are determined using a hash function.

The encryption area 333-3 may refer, for example, to an area for verifying integrity of the file object area 330. For this, the encryption area 333-3 stores an encryption value by using certification values determined from all information stored in the file meta area 333 and a predefined encryption algorithm. Here, the encryption algorithm may be an RSA algorithm that makes a public key and a private key into a set, and encrypts and decrypts the set.

Therefore, in operation S710, the file management apparatus 100 determines certification values of pieces of information included in the file meta area 333 and determines an encryption value of the file meta area 333 using the determined certification values and a predefined encryption algorithm by accessing the file meta area 333 of the file object area 330 storing a file for executing an application requested by a user based on information stored in the volume meta area 320 according to an execution command of the corresponding application.

In operation S720, the file management apparatus 100 accesses the file meta area 333 included in the file object area 330 based on information stored in the volume meta area 320 and compares an encryption value pre-stored in the file meta area 333 with a pre-determined encryption value.

If the pre-stored encryption value does not correspond to the pre-determined encryption value based on the comparison result, the file management apparatus 100 determines that an error occurs in integrity of the file object area 330 in operations S730 and S740.

If the pre-stored encryption value corresponds to the pre-determined encryption value, the file management apparatus 100 performs an integrity verification of the chunk area 331 included in the file object area 330. The integrity verification of the file object area 330 as described above may be performed just once the first time. For example, when an execution command of an executable file corresponding to a user command is initially input or a system is booted, the file management apparatus 100 may perform an integrity verification of the file object area merely once the first time.

If the integrity of the file object area 330 is verified, the file management apparatus 100 determines certification values of chunks of a file requested to be executed from the chunk area 331 included in the file object area 330 in operation S750. In operation S760, the file management apparatus 100 compares the determined certification values of the chunks of the file requested to be executed with certification values of the chunks of the file stored in the certification information area 333-2 of the file meta area 333. If at least one certification values of certification values of a plurality of chunks of the file requested to be executed do not correspond to each other, the file management apparatus 100 determines that an error occurs in integrity of the file requested to be executed.

If the certification values of the plurality of chunks of the file requested to be executed corresponds to one another, the file management apparatus 100 determines that the file requested to be executed has normal integrity in operation S780.

Before determining whether a file requested to be executed has integrity, the file management apparatus 100 according to the present disclosure may determine whether to perform an integrity verification of the corresponding file based on execution information about the file among a plurality of pieces of information stored in the volume meta area 320 and perform the above-described operation based on the determination result.

For example, the file management apparatus 100 determines whether a file requested to be executed is an image file such as “jpg” or an executable file for executing a program such as “exe” based on execution information of the corresponding file among a plurality of pieces of information stored in the volume meta area 320.

If the file requested to be executed is the executable file according to the determination result, the file management apparatus 100 may perform an integrity verification of the file by performing a series of processing operations described above. If the file requested to be executed is other file that is not executed such as an image or the like, the file management apparatus 100 may not perform the integrity verification of the file.

Also, before determining whether the file requested to be executed has integrity, the file management apparatus 100 may determine whether the super block area 310 has integrity.

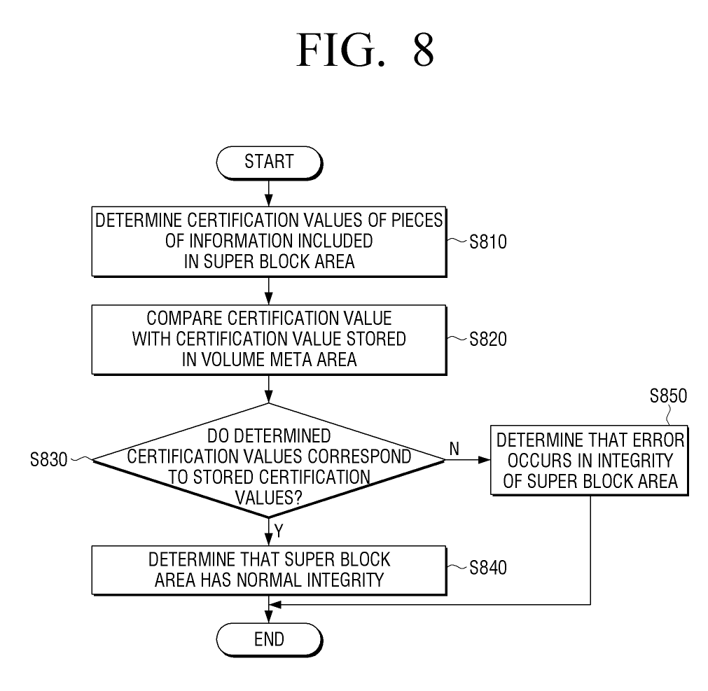

FIG. 8 is a flowchart illustrating an example method of determining whether a super block area of a volume has integrity in a file management apparatus, according to an example embodiment of the present disclosure.

As illustrated in FIG. 8, in operation S810, the file management apparatus 100 determines certification values of pieces of information included in the super block area 310 based on an execution command of an application requested by a user.

In operations S820 and S830, the file management apparatus 100 determines whether the certification values of the pieces of information included in the super block area 310 with certification values stored in the volume meta area 320 by comparing the certification values of the pieces of information with the certification values stored in the volume meta area 320.

If the certification values of the pieces of information included in the super block area 310 correspond to the certification values stored in the volume meta area 320 based on the determination result, the file management apparatus 100 determines that the super block area 310 has normal integrity in operation S840.

If the certification values of the pieces of information included in the super block area 310 do not correspond to at least one of the certification values stored in the volume meta area 320, the file management apparatus 100 determines that an error occurs in the integrity of the super block area 310 in operation S850.

Hereinafter, a method of verifying integrity of a file necessary for booting a system when initially booting the system in the file management apparatus 100 will be described in detail.

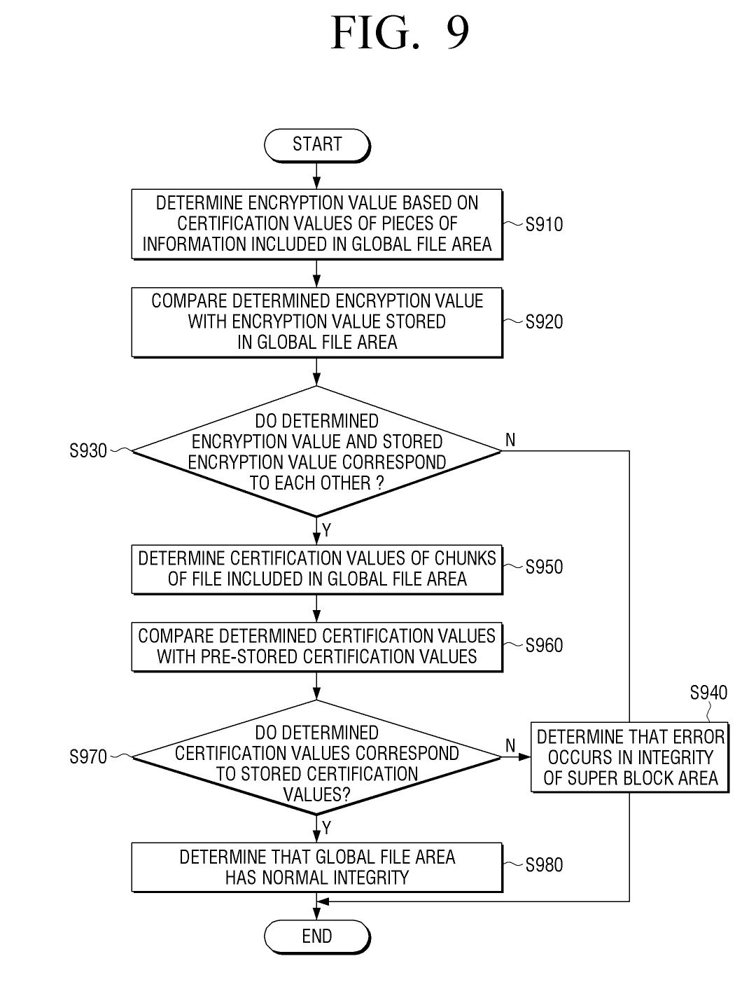

FIG. 9 is a flowchart illustrating an example method of verifying integrity of a file when booting a system in a file management apparatus, according to an example embodiment of the present disclosure.

Prior to descriptions of FIG. 9, the volume area 300 described above may further include the global file meta area 340. The global file meta area 340 may refer, for example, to an area that stores information about a particular file. Here, according to example embodiments, the particular file may be a file that is initially executed when booting the system. In other words, the particular file may be a file that needs to be initially accessed among files stored in the volume area 300 of the memory 130 when booting the system.

A plurality of files that need to be initially accessed may be stored in the global file meta area 340. In this case, as described above with reference to FIG. 5, the global file meta area 340 may include the global file information area 341, the global certification information area 342, and the global encryption area 343.

The global file information area 341 stores a plurality of chunks into which a plurality of pieces of data composing at least one file defined as a particular file are compressed, position information and compression information of each of the chunks, and the like.

The global certification information area 342 stores determined certification values of a plurality of chunks of at least one file stored in the global file information area 341 in a table form.

Also, the global encryption area 343 stores an encryption value that is determined using certification values determined from all information stored in the global file meta area 340 and a predefined encryption algorithm.

Therefore, if the system is initially booted, the file management apparatus 100 accesses the global file meta area 340 based on information stored in the volume meta area 320. In operation S910, the file management apparatus 100 determines certification values of pieces of information included in the global file meta area 340 and determines an encryption value of the global file meta area 340 using the determined certification values of the pieces of information and a predefined encryption algorithm. Here, the certification value may be a hash value that is determined through a hash function, and the encryption algorithm may be an RSA that makes a public key and a private key into a set, and encrypts and decrypts the set.

In operations S920 and 930, the file management apparatus 100 compares an encryption value pre-stored in the global encryption area 343 with a pre-determined encryption value and determines whether the global file meta area 340 has integrity based on the comparison result by accessing the global encryption area 343 included in the global file meta area 340.

If the pre-stored encryption value does not correspond to the pre-calculated encryption value according to the determination result, the file management apparatus 100 determines that an error occurs in integrity of the global file meta area 340 in operation S940.

If the pre-stored encryption value corresponds to the pre-stored encryption value, the file management apparatus 100 determines that the global file meta area 340 has integrity and performs an integrity verification of at least one file included in the global file information area 341. The integrity verification of the global file meta area 340 may be performed just once the first time. For example, the file management apparatus 100 may perform the integrity verification of the global file meta area 340 merely once the first one time when booting the system.

If the integrity of the global file information area 341 is verified, the file management apparatus 100 determines certification values of chunks of at least one file included in the global file information area 341 by accessing the global file information area 341 included in the global file meta area 340 in operation S950. In operations S960 and 970, the file management apparatus 100 determines whether a determined certification value corresponds to a certification value stored in the global certification area 342 included in the global file meta area 340 by comparing the determined certification value with the stored certification value

If at least one certification values do not correspond to each other based on the determination result, the file management apparatus 100 determines that an error occurs in a file stored in the global file information area 341. If determined certification values all correspond to pre-stored certification values, the file management apparatus 100 determines that the file stored in the global file information area 341 has normal integrity in operation S980.

The file management apparatus 100 according to the present disclosure as described above may improve a performance of a whole system by dispersedly storing a plurality of pieces of data comprising a file as units of chunks in the memory 130 and performing integrity verifications of the dispersedly stored chunks in comparison with an existing file management apparatus.

An integrity verifying method of the file management apparatus 100 according to various example embodiments described above may be coded as software and then stored on a non-transitory readable medium. The non-transitory readable medium may be installed and used in various types of apparatuses.

The non-transitory computer readable medium that may store data semi-permanently and is readable by devices. For example, the aforementioned applications or programs may be stored in the non-transitory computer readable media such as compact disks (CDs), digital video disks (DVDs), hard disks, Blu-ray disks, universal serial buses (USBs), memory cards, and read-only memory (ROM).

The foregoing example embodiments and advantages are merely examples and are not to be understood as limiting the present disclosure. The present teaching can be readily applied to other types of apparatuses. Also, the description of the example embodiments of the present disclosure is intended to be illustrative, and not to limit the scope of the claims, and many alternatives, modifications, and variations will be apparent to those skilled in the art.

What is claimed is:

1. A method of verifying integrity using a file management apparatus, the method comprising:
receiving a file comprising a plurality of pieces of data;
arranging the plurality of pieces of data of the file as units of chunks and storing the chunks in a memory;
determining whether the file has integrity by comparing a certification value of at least one of the chunks of the file with a pre-stored certification value corresponding to the at least one of the chunks based on an execution command; and
executing the file based on the integrity determination result.

2. The method of claim 1, wherein the memory stores:
a super block area configured to store information about a volume;
a volume meta area configured to store at least one of: information for managing the file and execution information of the file; and
a volume block comprising a file object area storing the file comprising the units of chunks and information about the file.

3. The method of claim 2, wherein the file object area comprises a file meta area configured to store certification values corresponding to the chunks of the plurality of pieces of data comprising the file,
wherein the determining the integrity comprises:
detecting positions of the chunks of the file and the file meta area from the file object area based on information stored in the volume meta area;
determining certification values of the chunks of the file based on the detected positions of the chunks; and
determining whether the file has integrity by acquiring certification values of the chunks of the file with reference to the detected file meta area and comparing the acquired certification values of the chunks with the determined certification values of the chunks.

4. The method of claim 3, wherein the file meta area further stores an encryption value that is determined based on certification values of pieces of information included in the file meta area and a predefined encryption algorithm,
wherein the determining the integrity further comprises:
determining certification values of the pieces of information included in the file meta area based on information stored in the volume meta area and determining an encryption value using the determined certification values and the encryption algorithm; and
determining whether the file object area has integrity by comparing the determined encryption value with an encryption value stored in the file meta area.

5. The method of claim 2, wherein the volume further comprises a global file meta area configured to store information about a particular file,
wherein the global file meta area stores an encryption value determined based on certification values of pieces of information comprising the particular file and a predefined encryption algorithm.

6. The method of claim 5, wherein the particular file comprises a file that is initially executed when booting a system.

7. The method of claim 5, wherein the determining the integrity comprises:
determining certification values of pieces of information comprising the global file meta area based on information stored in the volume meta area and determining an encryption value using the determined certification values and the encryption algorithm when booting the system;
comparing the determined encryption value with an encryption value stored in the global file meta area;
determining certification values of chunks of a file included in the global file meta area in response to the determined encryption value and the stored encryption value corresponding to each other; and
determining whether the file included in the global file meta area has integrity by comparing the determined certification values of the chunks with certification values of the chunks stored in the global file meta area.

8. The method of claim 2, wherein the determining the integrity comprises: determining whether the file has integrity in response to the file being determined as an executable file based on execution information comprised in the volume meta area.

9. The method of claim 3, wherein the volume meta area stores a certification value for verifying integrity of the super block area,
wherein the determining the integrity further comprises: determining whether the super block area has integrity by determining certification values of pieces of information included in the super block area and comparing the determined certification values with certification values stored in the volume meta area.

10. A file management apparatus comprising:
a memory configured to arrange a plurality of pieces of data of a file as units of chunks and to store the chunks; and
a processor configured to determine whether the file has integrity by comparing a determined certification value of at least one of the chunks of the file with a pre-stored certification value corresponding to the at least one the chunks and to execute the file based on the integrity determination result based on an execution command.

11. The file management apparatus of claim 10, wherein the memory stores:
a super block area configured to store all information about a volume;
a volume meta area configured to store at least one of: information for managing the file and execution information of the file; and
a volume block configured to include a file object area storing the file comprising the units of chunks and information about the file.

12. The file management apparatus of claim 11, wherein the file object area comprises a file meta area configured to store certification values corresponding to chunks of a plurality of pieces of data comprising the file,
wherein the processor comprises:
a file controller configured to detect positions of the chunks of the file and the file meta area from the file object area based on information stored in the volume meta area; and
a certification processor configured to determine certification values of the chunks of the file based on the detected positions of the chunks,
wherein the certification processor is configured to determine whether the file has integrity by acquiring certification values of the chunks of the file with reference to the detected file meta area and comparing the acquired certification values of the chunks with the determined certification values of the chunks.

13. The file management apparatus of claim 12, wherein the file meta area further stores an encryption value that is determined based on certification values of pieces of information included in the file meta area and a predefined encryption algorithm,
wherein the processor further comprises an encryption processor configured to determine certification values of the pieces of information included in the file meta area based on information stored in the volume meta area and determine an encryption value using the determined certification values and the encryption algorithm,
wherein the encryption processor is configured to determine whether the file object area has integrity by determining whether the determined
encryption value corresponds to an encryption value stored in the file meta area.

14. The file management apparatus of claim 11, wherein the volume further comprises a global file meta area configured to store information about a particular file,
wherein the global file meta area stores an encryption value determined based on certification values of pieces of information comprising the particular file and a predefined encryption algorithm.

15. The file management apparatus of claim 14, wherein the particular file comprises a file that is initially executed when booting a system.

16. The file management apparatus of claim 14, wherein when booting the system, the encryption processor is configured to determine whether the global file meta area has integrity by: determining certification values of pieces of information included in the global file meta area based on information stored in the volume meta area, determining an encryption value using the determined certification values and the encryption algorithm, and comparing the determined encryption value with an encryption value stored in the global file meta area,
wherein in response to the determined encryption value and the stored encryption value corresponding to each other, the certification processor determines whether a file included in the global file meta area has integrity by determining certification values of chunks of the file included in the global file meta area and comparing the determined certification values of the chunks with certification values of the chunks stored in the global file meta area.

17. The file management apparatus of claim 12, wherein the file controller is configured to determine whether the file has integrity in response to the file being determined as an executable file based on execution information included in the volume meta area.

18. The file management apparatus of claim 12, wherein the volume meta area stores a certification value for verifying integrity of the super block area,
wherein the certification processor is configured to determine whether the super block area has integrity by: determining certification values of pieces of information included in the super block area and comparing the determined certification values with certification values stored in the volume meta area.

19. The method of claim 1, further comprising:
selecting at least one chunk to be used from among a plurality of chunks stored in the memory;
calculating a certification value for the selected at least one chunk; and
comparing the calculated certification value with a predetermined certification value for the selected at least one chuck.

20. The file management apparatus of claim 10, wherein the processor is configured to select at least one chunk to be used from among a plurality of chunks stored in the memory, to calculate a certification value for the selected at least one chunk, and to compare the calculated certification value with a predetermined certification value for the selected at least one chuck.
